(19) United States
(12) Patent Application Publication
(10) Pub. No.: US 2005/0144165 A1
(43) Pub. Date: Jun. 30, 2005

(54) Method and system for providing access to content associated with an event

(76) Inventors: Mohammad Hafizullah, New York, NY (US); Michael Callahan, New York, NY (US)

Correspondence Address: James J DeCarlo;Stroock & Stroock & Lavan, 180 Maiden Lane, New York, NY, 10038, US

(21) Appl. No.: 10/482,947

(22) PCT Filed: Jul. 3, 2001
(86) PCT No.: PCT/US01/21366

(51) Int. Cl. G06F 17/30

(52) U.S. Cl. 707/6

(57) ABSTRACT

A content delivery system for delivering content received from one or more external sources to end users of the system via multiple communication paths. By way of non-limiting example, content such as a voice signal transmitted via a telephone network is received by a first server of the content delivery system. The first server alone or in concert with a second server converts and encodes the voice signal into a streaming format. In response to a request from an end user to receive the content via a selected communication path, the content delivery system converts and decodes the content, if necessary, to transmit the content via the selected communication path. The end user uses a computing device in communication the selected communication path to receive the content.

### FIELD OF THE INVENTION

The invention relates to the field of content delivery and, in particular, to a method and system for providing access to content associated with an event to end users via a plurality of communication paths.

### BACKGROUND OF THE INVENTION

Increasingly, information and entertainment content is being disseminated via the communications infrastructure designed to be the backbone of the Internet and wireless communications. These various communications paths include the Plain Old Telephone Systems (“POTS”), the world wide web, and satellite and wireless networks, to name a few. Recently, content providers have turned to “web-casting” as a viable broadcast option. Various events from live corporate earnings calls to live sporting events have been broadcast using the Internet and streaming video/audio players.

Generally speaking, web-casting (or Internet broadcasting) is the transmission of live or pre-recorded audio or video to personal computers or other computing or display devices that are connected to the Internet or other global communications network. Web-casting permits a content provider to bring both video and audio, which is similar to television and radio but of lesser quality, directly to the computer of one or more end users in formats commonly referred to as streaming video and streaming audio. In addition to streaming media, web-cast events can be accompanied by other multimedia components, such as, for example, slide shows, web-based content, interactive polling and questions, to name a few.

Web-cast events can be broadcast live or played back from storage on an archived basis. To view the web-cast event the end user must have a streaming-media player, such as for example RealPlayer™ (provided by Real Networks™, Inc.) or Windows® Media Player provided by Microsoft® Corporation, loaded on their computing device. Furthermore, as set forth above, web-casts that include other multimedia content such as slides, web content and other interactive components, will need at the very least a web browser, such as Netscape Navigator or Microsoft Internet Explorer. In general, the streamed video or audio is stored on a centralized location or source, such as a server, and pushed to an end user's computer through the media player and web browser.

Web-casts are increasingly being employed to deliver various business related information to end users. For example, corporate earnings calls, seminars, and distanced learning applications are being delivered via web-casts. The web-cast format is advantageous because a multimedia presentation that incorporates various interactive components can be streamed to end users all over the globe. As such, end users can receive streaming video or audio (akin to television or radio broadcasts) along with slide presentations, chat sessions, and web-based content, such as Flash® and Shockwave® presentations.

The widespread use of firewalls to protect corporate and home networks, however, has hampered the delivery of media rich content in the web-cast format. The common firewall prevents an end user inside the network from accessing non-HTTP content (or content transferred using the Hypertext Transfer Protocol). Generally speaking, all information that is communicated to a firewall protected network passes through the firewall and is analyzed. If the content does not meet specified conditions, it is blocked from the network. For various reasons, corporate and home firewalls block non-HTTP content, such as streaming media. Thus, media rich web-casts cannot be streamed to many prospective end users.

Firewalls, however, are not the only obstacle to the proliferation of web-casting. To date, there are no sufficient means for delivering web-cast content to end users who for various reasons are away from their personal computers. Thus, the inability of known systems to deliver web-cast and other streaming content to end users in multiple formats that can be accessed using a variety of communications and computing devices, such as for example, personal computers, wireless telephones, personal digital assistants (PDAs), and mobile computers, and the like, has hindered the growth of web-casting.

As such, there is a need for a system and method of delivering media rich web-casts in multiple delivery formats that enables potential end users to receive and participate in the web-cast behind firewalls, and from mobile locations.

### SUMMARY OF THE INVENTION

The present invention overcomes shortcomings of the prior art. The present invention provides for the delivery of content associated with an event, whether on a live or archived basis, to end users via a variety of communications paths. In addition, the present invention enables end users to receive the content on a variety of communications devices.

According to an exemplary embodiment of the present invention, a system for providing access to content associated with an event generally comprises a server system that is capable of storing and transmitting the content to the end users via multiple communications paths. The server system is communicatively connected to external content sources, which generally capture events and communicate the content associated with the events to the server system for processing, storing, and transmission to end users. The server system also comprises a plurality of interfaces that are communicatively connected to multiple communications paths. End users desiring to receive the content can choose to receive all or a portion of the content on any one of the communications paths using a variety of communications devices. In this way, end users access to the content is not limited by the particular communications device that an end user is using.

Generally speaking, the server system comprises a first converter for receiving and encoding content transmitted from an external source. As will be described further, in one exemplary embodiment, the first converter captures voice data transmitted to the server system via POTS, converts the voice data into an audio file (e.g., a PCM or WAV file), and encodes the audio file into a streaming media file.

The server system also comprises a media storage and transmission server communicatively connected to the interfaces for providing access to the encoded content to end users. The interfaces may include connections to communications paths, including but not limited to the Internet, the Public Switched Telephone Network (“PSTN”), analog and digital wireless networks, and satellite networks.

Accordingly, a live video or audio feed can be received and formatted for delivery through a plurality of interfaces and received by end users using a variety of communications devices. In this way, end users can participate in an event irrespective of the type of communication device the end user is using. For example, an end user who is traveling can call a designated telephone number using a wireless phone and access the audio component of an event. By way of further example, an end user can attend a virtual seminar broadcast over the Internet even when the network is blocked by a firewall. In this instance, the non-streaming component of an event (e.g., slides, chat windows, poll questions, etc.) can be viewed through the end user's web browser. The audio component could then be simultaneously accessed via telephone. As a further example, in an alternative embodiment, the video feed could be formatted for viewing on a handheld computing device, such as a Personal Digital Assistant (“PDA”) or web-ready wireless phone. As can be seen, the present invention satisfies the need for a streaming-content multi-access delivery system.

By providing access via multiple communication paths, end users can access and participate in various events, including web-cast events while at work, at home, or on the road. For example, by combining usage of the two or more of the interfaces, an end user can receive non-streaming content, such as Flash® or Shockwave® presentations and slide images, on a personal or network computer on a Local Area Network (“LAN”), which is protected by a firewall, while receiving the audio component of the web-cast via dial-up access. Thus, the various embodiments of the present invention overcome the limitations of present content delivery systems.

Other objects and features of the present invention will become apparent from the following detailed description, considered in conjunction with the accompanying system schematics and flow diagrams. It is understood, however, that the drawings, which are not to scale, are designed solely for the purpose of illustration and not as a definition of the limits of the invention, for which reference should be made to the attended claims.

### BRIEF DESCRIPTION OF THE DRAWING FIGURES

In the drawing figures, which are not to scale, and which are merely illustrative, and wherein like reference numerals depict like elements throughout the several views:

FIG. 1 is a schematic diagram of an overview of a preferred embodiment of the system architecture of a content delivery system in accordance with the present invention;

FIG. 2 is a flow diagram of a process of configuring the content delivery system of FIG. 1 to capture content from external sources in accordance with a preferred embodiment of the present invention;

FIG. 3 is a flow diagram of a process of capturing live voice data in accordance with a preferred embodiment of the present invention;

FIG. 4 is a flow diagram of a process of capturing live video and/or audio in accordance with a preferred embodiment of the present invention;

FIG. 5 is a data flow schematic of the delivery of content to an end user via a telephone network in accordance with a preferred embodiment of the present invention;

FIG. 6 is a data flow schematic of the delivery of content to an end user via the Internet in accordance with a preferred embodiment of the present invention; and

FIG. 7 is a flow diagram of a process of integrating non-streaming media into an event for delivery to end user in accordance with a preferred embodiment of the present invention.

### DETAILED DESCRIPTION OF THE PREFERRED EMBODIMENTS

There will now be shown and described in connection with the attached drawing figures several preferred embodiments of a system and method of providing access to live and archived events via a plurality of communications paths 190a, 190b, and 190c.

As used herein, the term “event(s)” generally refers to the broadcast via a global communications network of video and/or audio content which may be combined with other multimedia content, such as, by way of non-limiting example, slide presentations, interactive chats, questions or polls, and the like.

The term “communications paths” refers generally to any communication network through which end users may access content including but not limited to a network using a data packet transfer protocol (such as the Transmission Control Protocol/Internet Protocol (“TCP/IP”), User Datagram Protocol/Internet Protocol (“UDP/IP”)), a plain old telephone system (“POTS”), a cellular telephone system (such as the Advance Mobile Phone Service (“AMPS”)), or a digital communication system (such as GSM, TDMA, or CDMA).

The term “interfaces” generally refers to any device for connecting the server system to one or more of the communications paths, including but not limited to modems, switches, etc.

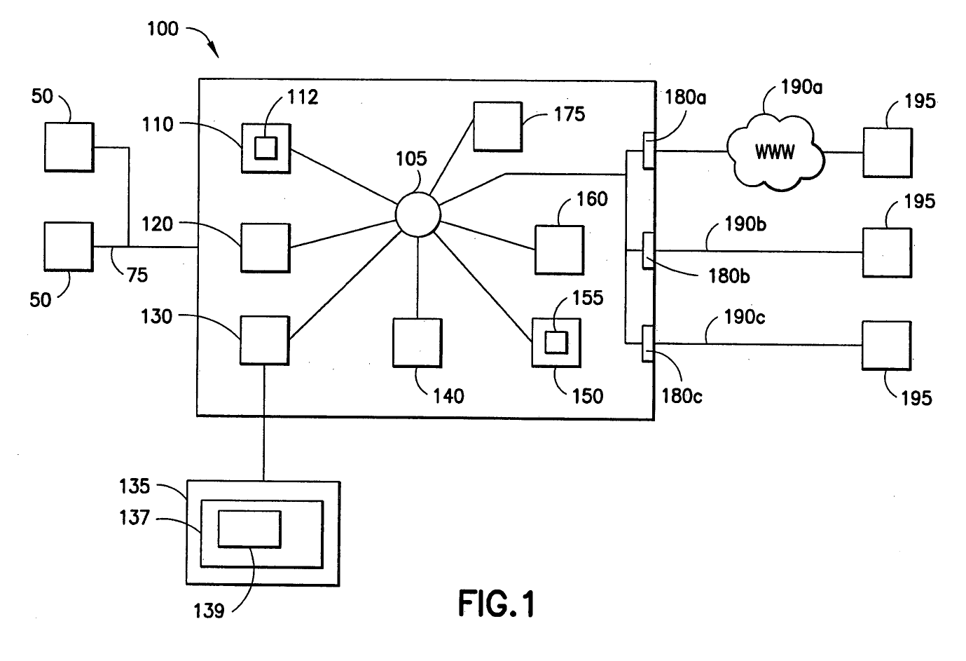

Referring generally to FIGS. 1-7, according to an exemplary embodiment of the present invention, content associated with an event may be received (on a live basis) or stored (on an archived) on a content delivery system 100. As will be described in more detail below, access information is provided to the end user to enable the end user to select the medium through which the end user desires to receive the content. Typically, the end user will perform an action, such as clicking a web link or dialing the provided telephone access number, to indicate to the content delivery system 100 a selection to receive the content via one of any number of communications paths 190a, 190b, 190c. In response to receipt of the end user's indication, the content delivery system 100 transmits the content to a communications device 195 via the selected communications path 190a, 190b, 190c.

System Architecture

With reference to FIG. 1, there is shown an exemplary embodiment of a content delivery system 100 in accordance with the present invention.

The content delivery system 100 generally comprises one or more servers programmed and equipped to receive content data from an external source 50 (either on a live or archived basis), convert the content data into a streaming format, if necessary, store the data, and deliver the data to end users through various communication paths 190a, 190b, 190c. In a preferred embodiment shown in FIG. 1, the content delivery system 100 comprises a first server 110 for receiving and converting content data, a second server 120 for encoding the converted content data (or in some embodiments receiving content data directly from the external sources 50), a third server 130 and an associated web-cast content administration system 135 for storing and delivering the content, a fourth server 140 for decoding the content stored on the web-cast content administration system 135, and a fifth server 150 for converting the content decoded by the fourth server so that the content can be delivered to a voice communications device.

It will be understood that each of the servers 110, 120, 130, 140, and 150, and the web-cast content administration system 135 are each communicatively connected via a local or wide area network 105 (“LAN” or “WAN”). In turn, the first and second servers 110, 120 are in communication with one or more external sources 50. Similarly, the third and fifth servers 130, 150 are in communication with various communication paths 190a, 190b, 190c through interfaces 180a, 180b, and 180c, so as to deliver the content to end users.

In an exemplary embodiment of the content delivery system 100, as shown in FIG. 1, first server 110 is preferably equipped with a video/audio content capture device 112, which is communicatively connected to external sources 50.

Capture device or card 112 enables the first server 110 to receive telephone, video, or audio data from an external source 50 and convert the data into a digitized, compressed, and packetized format, if necessary. The first server 110 is preferably implemented in one or more server systems running an operating system (e.g. Windows NT/2000 or Sun Solaris) and being programmed to interface with an Application Program Interface (“API”) exposed by the capture device 112 so as to permit the first server 110 to receive telephone, video, or audio content data on a live or archived basis. The content data, in the case of analog voice data, is then converted into a format capable of being encoded by the second server 120. One or more capture cards 112 may be implemented in the first server 110 as a matter of design choice to enable the first server 110 to receive multiple types of content data. By way of non-limiting example, capture devices 112 may be any telephony capture device, such as for example Dialogic's QuadSpan Key1 card, or any video/audio capture device known in the art. The capture devices 112 may be used in combination or installed in separate servers as a matter of design choice. For instance, any number of capture devices 112 and first servers 110 may be utilized to receive telephone, video, and/or audio content data from external sources 50 as are necessary to handle the broadcasting loads of the content delivery system 100.

External source 50 is any device capable of transmitting telephone, video, or audio data to the content delivery system 100. Such data may be received by the content delivery system 100 through a communications network 75, such as, by way of non-limiting example, the Public Switched Telephone Network (PSTN), a wireless network, a satellite network, a cable network, or transmission over the airwaves or any other suitable communications medium. By way of non-limiting example, external sources 50 may include but are not limited to telephones, cellular or digital wireless phones, or satellite communications devices, video cameras, and the like. In the case of video and audio data other than voice communications, the external sources may transmit analog or digital television signals (e.g., NTSC, PAL, and HDTV signals) or radio signals (e.g., FM or AM band frequencies).

As will be described further below, when an event is scheduled, the first server 110 is pre-configured to receive the content data. Depending on the format of the raw content, i.e., standard telephone signals, analog or digital television signals (NTSC, PAL, HDTV, etc.), or streaming video or audio content, the first server 110 functions to format the raw content so that it can be encoded and stored on the third server 130 and the associated web-cast content administration system 135. In the case of standard telephone signals, the first server 110 operates with programming to digitize, compress, and packetize the signal. Generally speaking, the telephone signal is converted to a VOX or WAV format of packetized data. Because NTSC, PAL, and HDTV television signals can be encoded by the second server 120 without conversion, the first server 110 either simply encodes the signal or passes the signal directly to the second server 120 on a pre-defined port setting. If the incoming video or audio feed is already in streaming format, which requires no conversion or encoding, the first server 110 can pass the streaming content directly to the media server 130.

Referring again to FIG. 1, the second server 120 is preferably a standalone server system interconnected to both the first server 110 and the third server 130 via the LAN/WAN 105. It will be understood, however, that the functionality of the second server 120 can be implemented in the first server 110. Conversely, to handle large amounts of traffic any number of second servers 120 may be used to handle traffic on the content delivery system 100. The second server 120 is programmed to encode the converted video or audio content into a streaming media format. The second server 120 is preferably programmed with encoding software capable of encoding digital data into streaming data. By way of non-limiting example, such encoding software is available from Microsoft® and/or Real Networks®. One skilled in the art will recognize that the process of encoding audio and video data into streaming media formats may be performed in any number of ways now known or hereafter developed. Once the content has been encoded into a streaming media format, it is passed to the third server 130 and the associated web-cast content administration system 135 where it is stored and made available to end users.

The third server 130 is interconnected to the first server 110 and second server 120 via the LAN/WAN 105. The third server 130 is also communicatively connected to end users via a global communications network 200, such as the Internet. As shown in FIG. 1, the third server 130 is also preferably connected to fourth and fifth servers 140 and 150, respectively, for decoding and converting the content prior to transmission to end users when necessary for access through an voice communications medium such as cellular/satellite and public telephone networks.

The content delivery system 100 also comprises a fourth server 140, for converting the streaming contents stored on the media server 130 into a format acceptable to be transmitted over one of the communication paths 190a, 190b, 190c. For example, a streaming audio file or the streaming audio component of a video stream generally must first be converted into a non-streaming audio file, such as a .PCM or .WAV file, prior to being transmitted into an end user's telephone via the PSTN. In an embodiment, described below, fourth server 140 operates in conjunction with a fifth server 150 for converting the decoded audio file into a voice signal capable of being transmitted to a telephone. Of course, it will be understood that the audio file can be converted into either analog or digital form. Similar to the first server 110, the fifth server 150 is equipped with a telephony interface device 155 such as Dialogic's QuadSpan Key1.

As will be described further below, an end user can dial into the content delivery system 100 using a specified telephone access number to interface with the telephony interface device 155 of fifth server 150. It should be noted that an advantage of the present invention is that through the above-described system architecture an end user can select the medium through which he/she prefers to receive the data. Thus, the end user may also connect with the third server 130 through communications path 190a via a web browser. In addition, these multiple interface connections enable the end user to receive both the audio and multimedia components of an event simultaneously.

With further reference to FIG. 1, a web server 175 may be interconnected to the LAN/WAN 105 as part of the content delivery system 100 or the web server bay be operated as a stand-alone system. Generally speaking, as it relates to the present invention web server 175 functions to transmit access information for various events to end users.

Although not depicted in the figures, the servers described herein generally include such other art recognized components as are ordinarily found in server systems, including but not limited to RAM, ROM, clocks, hardware drivers, and the like. The servers are preferably configured using the Windows® NT/2000, UNIX or Sun Solaris operating systems, although one skilled in the art will recognize that the particular configuration of the servers is not critical to the present invention.

CONTENT CAPTURE

a. Configuring the Content Delivery System

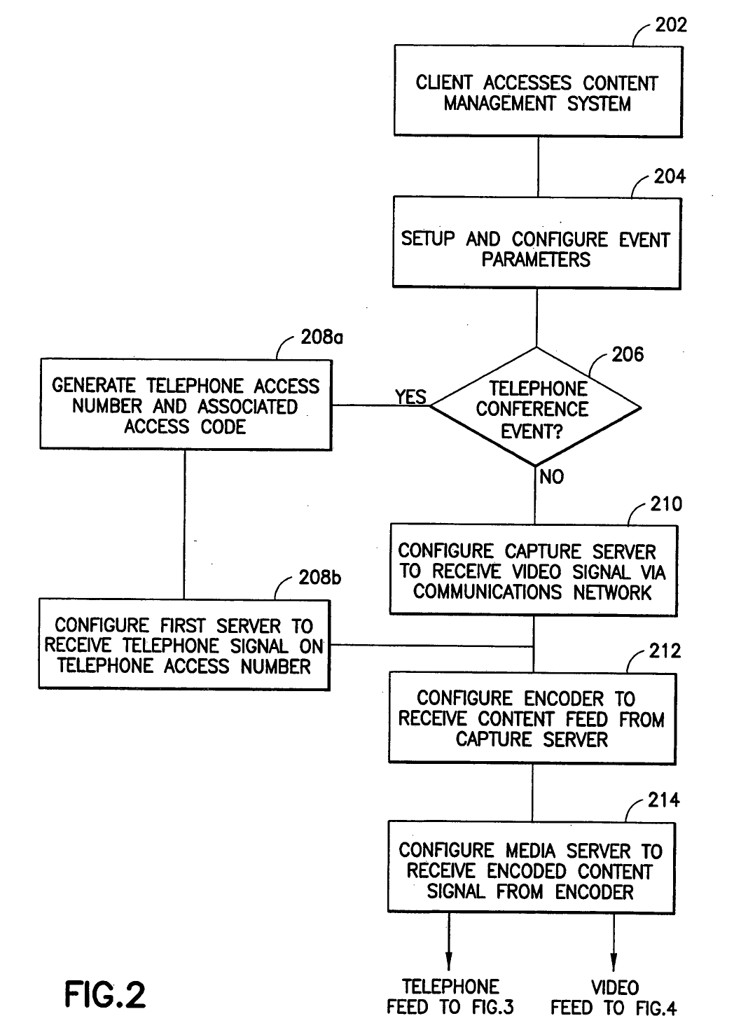

With reference to FIG. 2, there is shown a flow diagram of an exemplary process of configuring the content delivery system 100.

In a first step 202, a client accesses web-cast content administration software operating on the content delivery system 100. The web-cast content administration software functions to receive data from the client regarding a particular event and to configure the content delivery system according to the received event data. In step 204, as prompted by the web-cast content administration software, the client configures the event parameters that include information such as, for example, the time of the event, the look and feel of the event (if graphical), content type, etc. In step 206, the web-cast content administration software determines whether the event is a telephone conference event, i.e., the content data is voice data as generated by a telephone. If the event is a telephone conference event, then the web-cast content administration software generates a telephone access number and associated PIN code to be used by the client in establishing a connection with the content delivery system 100, in step 208a. In step 208b, the first server 110 is configured to receive the telephone signal on the particular telephone access number.

Alternatively, if the event content will be received via a video or audio feed, then in step 210 the first server 110 is configures to receive the video signal via a communications network. In step 212, the second server 120 is configured to receive the captured content data from the first server 110. Similarly, the third server 130 is configured to receive the encoded content data from the second server 120, in step 214. One skilled in the art will recognize that the process of configuring the servers can be performed in any number of ways as long as the servers are in communication and have adequate resources to handle the incoming content data.

b. Live Telephone Feed Capture

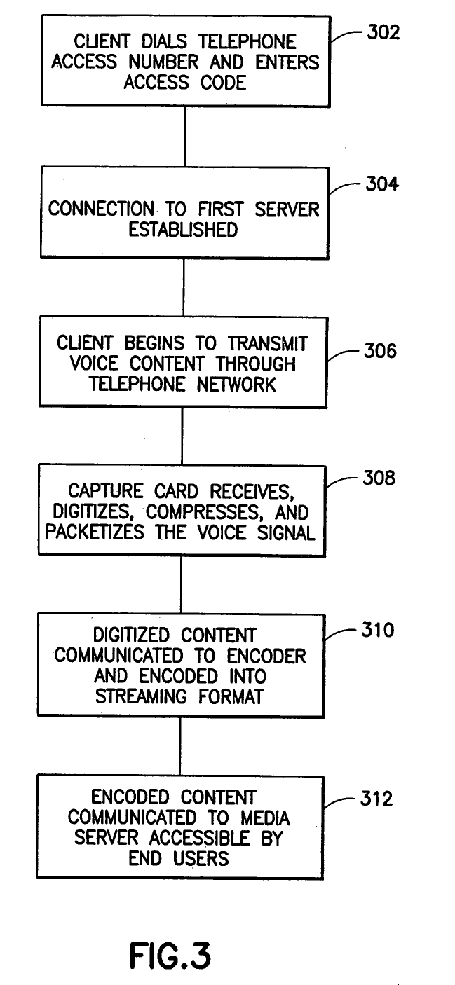

With reference now to FIG. 3, there is shown a flow diagram of an exemplary process of capturing voice content from a telephone call.

Prior to hosting a live event, the content delivery system 100 is configured to receive the content data and make it available to end users. Generally speaking, the capture device 112 of first server 110 is configured to receive the content from a specified external source 50. By way of example only, software operating on the content delivery system 100 assigns a unique identifier (or PIN) to a telephone access number associated with a telephone line hard-wired to the capture device 112. The capture device 112 preferably includes multiple channels or lines through which calls can be received.

In the case of a preferred embodiment, a telephony interface device (e.g., Dialogic's QuadSpan Key1). When an event is scheduled, one or more lines are reserved for the event and the client (i.e., the person(s) producing the content to be delivered to prospective end users) is given an access number to call to interface with the system. The client (or host) uses the telephone access number and PIN with which to dial into the first server 110 of the content delivery system 100 at the time the conference call is scheduled to take place. In addition to configuring the capture device 112, the second server 120 and third servers 130 are configured to reserve resources for the incoming content data. One skilled in the art will recognize that the process of scheduling the event and configuring the content delivery system 100 can be performed in any number of ways as a matter of design choice.

In anticipation of the conference call, the capture device 112 of the first server 110 is set to “standby” mode to await a call made on the specified telephone access line, in step 302. When the call is received, the content capture device 112 prompts the host to enter the PIN. If the correct PIN is entered, the data capture device 112 establishes a connection, in step 304, and begins to receive the call data from the client through the telephone network, in step 306. In step 308, as the content data is received, it is digitized (unless already in digital form), compressed (unless already in compressed form), and packetized by programming on the capture device 112 installed the first server 110. The above step is performed in a manner known in the art. This functions to packetized the voice data into IP packets that can be communicated via the Internet using TCP/IP protocols.

In step 310, the converted data is then passed to the second server 120, which functions to encode the data into a streaming data. Encoding applications are presently available from both Microsoft and RealMedia and can be utilized to encode the converted file into streaming media files. One skilled in the art will understand that while the present invention is described in connection with RealMedia and Windows Media Player formats, the second server 120 can be programmed to encode the converted voice transmission into any other now known or later developed streaming media format. The use of a particular type of streaming format is not critical to the present invention.

In step 312, once the data is encoded into a streaming media format (e.g., .asf or .rm), it is passed to the third server 130. In a live event, the data is continuously received, converted, encoded, passed to the third server 130, and delivered to end users. During this process, however, the converted/encoded content data is recorded and stored on a web-cast content administration system 135 so as to be accessible on an archived basis. The web-cast content administration system 135 generally includes a database system 137 and associated storage (such as a hard drive, optical disk, or other data storage means) having a table 139 stored thereon that manages various identifiers by which streaming content is identified. Generally speaking, content stored on the web-cast content administration system 135 is preferably associated with a stream identifier (StreamId) that is stored in database table 139. The StreamId is further associated with the stream file's filename and physical location on the database 137, an end user PIN, and other information pertinent to the stream file such as the stream type, bit rate, etc. As will be described below, the StreamId is used by the content delivery system 100 to locate, retrieve and transmit the content data to the end user.

One skilled in the art will understand that as a matter of design choice any number and configurations of third servers 130 and associated databases may be used separately or in tandem to support the traffic and processing needs necessary at any given time. In a preferred embodiment, a round robin configuration of third servers 130 is utilized to support end user traffic.
a. Live Video/Audio Feed Capture

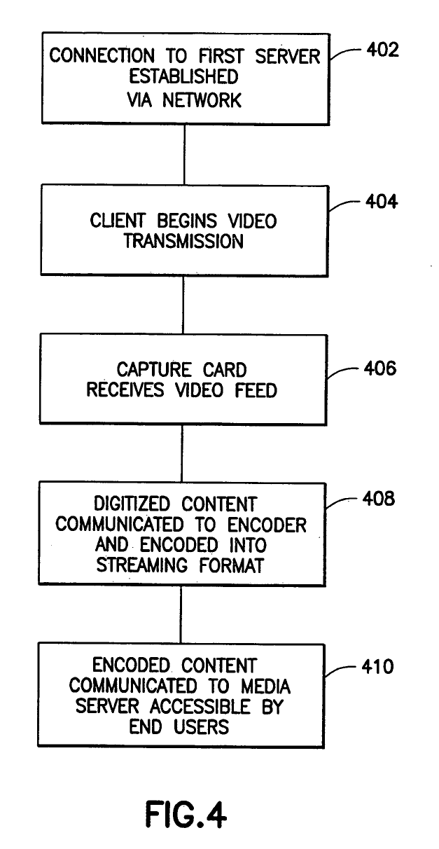

In an alternate embodiment of the present invention, a live video feed (e.g., a television signal) or audio feed (e.g., a radio signal) maybe transmitted to the content delivery system 100. An exemplary process of capturing the live video/audio feed is shown in FIG. 4.

In general, live video feeds are de-mixed into their respective video and audio components so as to be transmissible to end user in any desired format via the several connected communications paths 190a, 190b, 190c to various user devices 195. Once the feed components are de-mixed, each can be encoded into a streaming media format, as described above. The encoded video and/or audio streams are then communicated to the third server 130 and can be provided to end users via multiple communications paths.

In the case of a television or video signal, by way of example only, an end user can receive all of the components of the event, such as for example the video component, the audio component, and any interactive non-streaming component that may be included with the event. For instance, if the end user is behind a firewall, the end user might only be able to receive non-streaming components of the event on his/her personal or network computer. However, using the content delivery system 100 of the present invention, the end user can access non-streaming components on his/her computer while accessing the audio component of the event via the telephone dial-up access option described above.

With reference to FIG. 4, in step 402, a communication connection to the first server 110 is established. Generally speaking, resources on a video/audio capture device 112 of the first server 110 are reserved for the event and the first server 110 is configured to receive the signal through a specific input feed from external source 50. One skilled in the art will recognize that the process of scheduling the event and configuring the content delivery system 100 can be performed in any number of known ways. In step 404, the transmission begins and, in step 406, the video/audio signal is captured by the first server 110 and passed to the second server 120, which encodes the video/audio signal into a streaming media file, in step 408. In most instances, because the video/audio signal can be handled directly by the encoding programming of the Second server without further conversion, there is no need to digitize or compress the video/audio signal. However, such digitization and compression would be performed in a manner similar to the process described above in connection with the voice signal.

In step 410, once the content is encoded into a streaming media format (e.g., .asf or .rm), it is passed to the third server 130. As described above, the streaming data is associated with a StreamId and other pertinent information such as the location, filetype, stream type, bit rate, etc.

CONTENT DELIVERY

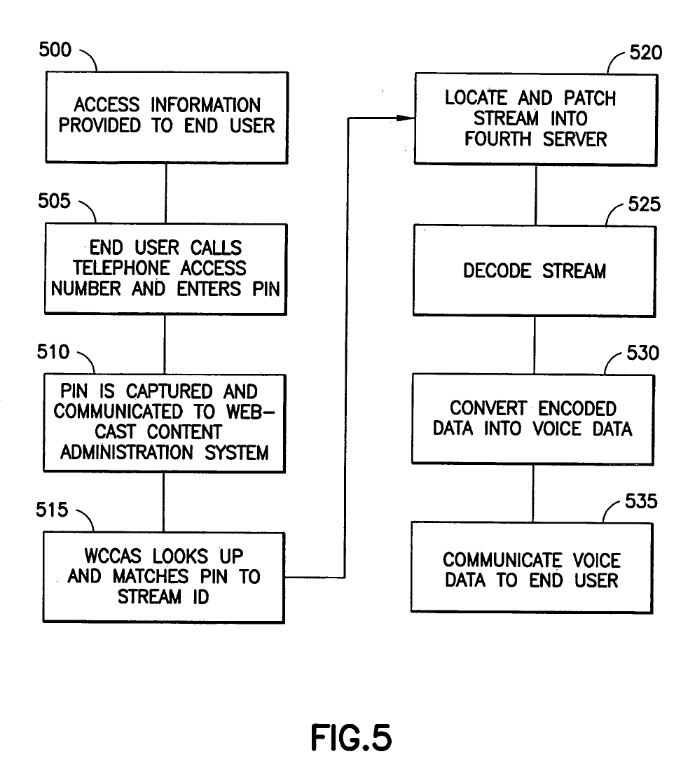

With reference again to FIG. 1, the content delivery system 100 provides access to the streaming content via multiple communications paths 190a, 190b, 190c. In connection with FIG. 5, there will now be described and shown an exemplary embodiment of delivery of audio/voice data transmitted to an end user via telephone network 190b.
a. Telephone Access

In step 500, information relating to how to access the event content is provided to the end user. In a preferred embodiment, a telephone access number is provided to the end user in a web site having basic information about the event. This web site may be served by web server 175 or a web server operated by the client. In addition, by way of example, end users can be provided the access number and PIN via e-mail, written communication, or any other information dissemination method.

In step 505, the end user calls the telephone access number to establish a connection between the content delivery system 100 and the end user's communication device 195, in this example a cellular phone. Once a connection is established, programming on the fifth server 150 prompts the end user to enter his/her PIN code to gain access to the content. In step 510, the end user's PIN is captured by the telephony interface device 155, which communicates the PIN to the web-cast content administration system 135. In step 515, the web-cast content administration system 135 looks up and matches the PIN with the StreamId of the requested content. Using the StreamId, the web-cast content administration system 135 looks up the location of the data (e.g., the broadcast part) on the third server 130. In step 520, the web-cast content administration system 135 locates the identified stream data on the first server 130, which in turn patches the stream into decoding programming of the fourth server 140. In step 525, the fourth server 140 decodes the stream into a non-streaming format (e.g., WAV or PCM). In step 530, the decoded data is passed to the telephony interface device 155 of the fifth server 150, which converts the decoded data into voice data. In step 535, the voice data is output and communicated to the voice communication device of the end user via a telephone network such as PSTN or cellular networks, to name a few. The result is that the end user can receive the stream using a telephone, even though the end user's computer could not receive the stream because it is on a network protected by a firewall.
b. World Wide Web Access

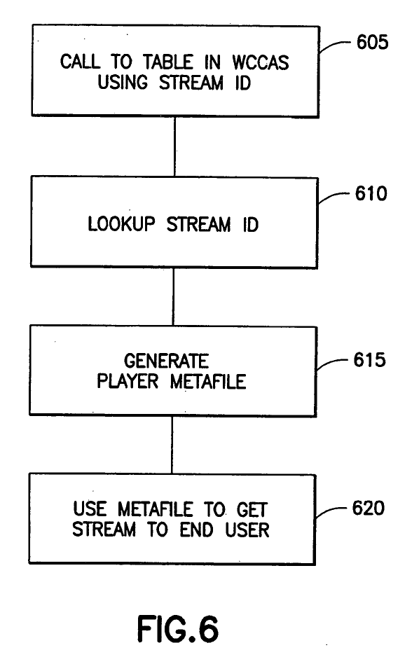

Referring back to FIG. 1, the third server 130 is preferably connected to the Internet, for example, or some other global communications network, shown as communications path 190a. In this respect, the content delivery 100 system also provides an access point to the streaming content through the Internet. With further reference to FIG. 6, a preferred embodiment of a process of accessing the streaming content through the Internet is shown and described below.

Upon completion of the scheduling and production phase of the event, a uniform resource locator (URL) or link is preferably embedded in a web page accessible to end-users. Any end users desiring to receive event can click on the URL. Preferably, a StreamId is embedded within the URL, as shown in exemplary form below:
<A href=“webserver.com/getstream.asp?streamid=12345”>

The illustrative URL shown above points to the web server 175 that will execute the indicated “getstream.asp” program. One skilled in the art will recognize that although “getstream” application has an Active Server Page (or ASP) extension, it is not necessary to use ASP technologies. Rather, any programming or scripting language or technology could be used to provide the desired functionality. It is preferred, however, that the program run on the server side so as to alleviate any processing bottlenecks on the end user side.

Referring now to FIG. 6, in step 605, the “getstream” application makes a call to the database table 139 using the embedded stream identifier. In step 610, the stream identifier is looked up and matched with a URL prefix, a DNS location, and a stream filename. In step 615, a metafile containing the URL prefix, DNS location, and stream filename is dynamically generated and passed to the media player on the end user computer. An example of a metafile for use with Windows Media Technologies is shown below:

```
<ASX>
    <ENTRY>
        <REF HREF=“mms://mediaserver.location.com/stream1.asf”>
    </ENTRY>
</ASX>
```

One skilled in the art will recognize, of course, that different media technologies utilize different formats of metafiles and, therefore, that the term “metafile” is not limited to the ASX-type metafile shown above. In step 620, the end user's media player pulls the identified stream file from the third server 130 identified in the metafile and plays the stream.

c. Non-Streaming Media Integration

In an alternate embodiment, shown in FIG. 1, the content delivery system 100 may also include a non-streaming content server 160 that is used to push non-streaming content to the end user either in a pushed fashion or as requested by the end user. Because the non-streaming content server uses the Hypertext Transfer Protocol (“HTTP”) and the content is of non-streaming format, the content can be received behind a firewall. In this way, an end user whose computer resides behind a firewall can dial in to receive the audio stream while watching a slide show on his/her computer. As will be discussed in further detail, several non-streaming content components can be incorporated into such an event.

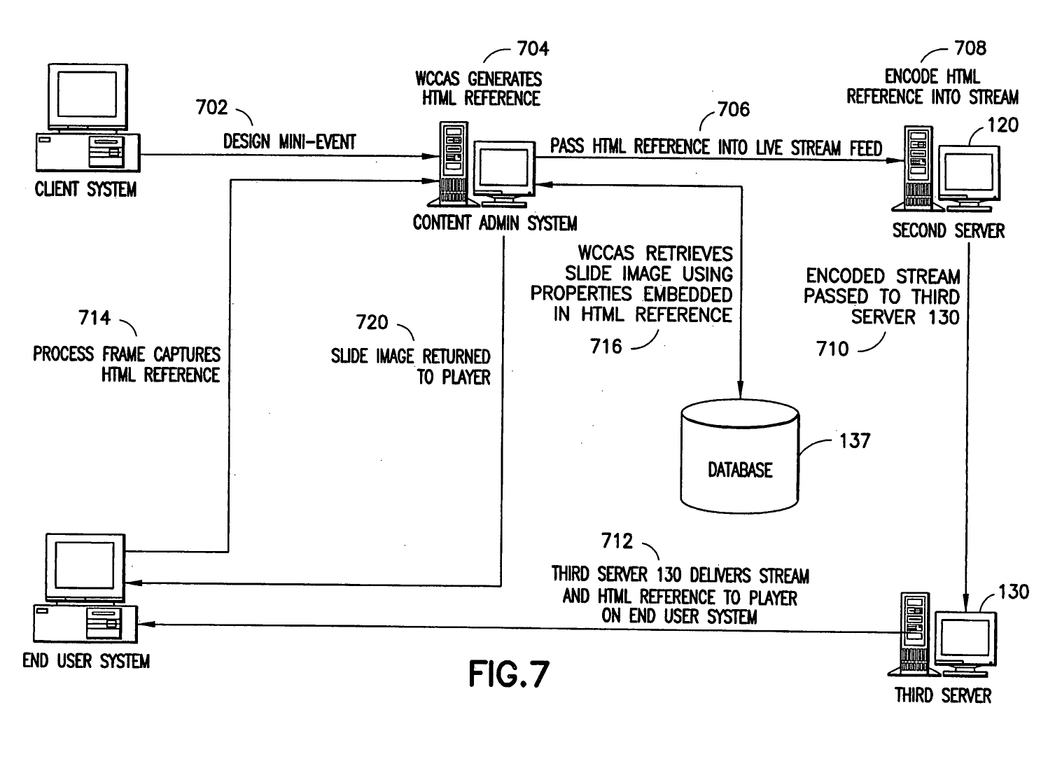

Turning now to FIG. 7, an exemplary embodiment of the operation of a software program processed by the content server 160 to allow the client to incorporate various media content into an event while it is running live is shown. The exemplary embodiment is described herein in connection with the incorporation of slide images that are pushed during the live event to a computing device of the end user. It should be understood, however, that any type of media content or other interactive feature could be incorporated into the event in this manner.

Referring again to FIG. 7, the client accesses a live event administration functionality of the web-cast content administration software (“WCCAS”) to design a mini-event to include in the live event, in step 702. The WCCAS then generates an HTML reference file, in step 704. The HTML reference contains various properties of the content that is to be pushed to the multimedia player. For instance, the HTML reference includes, but is not limited to, a name identifier, a type identifier, and a location identifier. Below is an exemplary HTML reference:
http://webserver.co.com/process.asp?iProcess=2&contentloc=“&sDatawindow&”&name=“&request.form(“url”)

The “iProcess” parameter instructs the “process” program how to handle the incoming event. The “contentloc” parameter sets the particular data window to send the event. And, the “name” parameter instructs the program as to the URL that points to the event content. As described above, during event preparation, the client creates the event script which is published to create an HTML file for each piece of content. The HTML reference is a URL that points to the URL associated with the HTML file created for the pushed content.

The WCCAS then passes the HTML reference to the live feed coming in to the second server 120, in step 706. The HTML reference file is then encoded into the stream as an event, in step 708. In this way, the HTML reference file becomes a permanent event in the streaming file and the associated content will be automatically delivered if the stream file is played from an archived database. This encoding process also synchronizes the delivery of the content to a particular time stamp in the streaming media file. For example, if a series of slides are pushed to the end user at different intervals of the stream, this push order is saved along with the archived stream file. Thus, the slides are synchronized to the stream. These event times are recorded and can be modified using the development tool to change an archived stream. The client can later reorder slides.

In step 710, the encoded stream is then passed to the third server 130. Preferably, the HTML reference generated by the WCCAS is targeted for the hidden frame of the player on the end user's system. Of course, one skilled in the art will recognize that the target frame need not be hidden so long as the functionality described below can be called from the target frame. As shown above, embedded within the HTML reference is a URL calling a “process” function and various properties. When the embedded properties are received by the ASP script, the ASP script uses the embedded properties to retrieve the content or image from the appropriate location on the web-cast content administration system 135 and push the content to the end user's player in the appropriate location.

Next, the third server 130 delivers the stream and HTML reference to the player on the end user system, in step 712. The targeted frame captures and processes the HTML reference properties, in step 714.

In the exemplary embodiment, the name identifier identifies the name and location of the content. In an alternate example, the “process.asp” program accesses (or “hits”) the web-cast content administration database 137 to return the slide image named “slide1” to the player in appropriate player window, in step 716, although this is not necessary. The type identifier identifies the type of content that is to be pushed, e.g., a poll or a slide, etc. In the above example, the type identifier indicates that the content to be pushed is a JPEG file. The location identifier identifies the particular frame, window, or layer in the web-cast player that the content is to be delivered. In the above example, the location identifier “2” is associated with an embedded slide window.

The content is then returned to the player in the appropriate window, in step 720.

By way of further example only, an HTML web page or flash presentation could be pushed to a browser window. By way of further example, an answer to a question communicated by an end user could be pushed as an HTML document to a CSS layer that is moved to the front of the web-cast player by the “process.asp” function.

In this way, the client can encode any event into the web-cast in real-time during a live event. Because the target frame functions to interpret the embedded properties in the HTML reference—rather than simply sending the content to a frame, the content is seamlessly incorporated into the player.

An advantage of use of this system is that an end user, whose computer resides on a network having a firewall, can receive the event content via one or more communication paths 190a, 190b, 190c. For instance, the integrated non-streaming components of an event, as described above, could be receive through the firewall on an end user's personal computer, while the streaming components (e.g., streaming video or audio) could be simultaneously received via a second communications path 190a, 190b, 190c. By way of example, a video feed can be de-mixed into its audio and visual components. Further, a non-streaming component can be integrated. The end user could be provided a telephone access number and PIN to access the audio component via a telephone while watching the slides on his/her computer. In addition, the video or audio components could be accessed by the end user on a portable device 195, such as a personal digital assistant or other handheld device, via wireless data transmission on a wireless communications path 190c.

While the invention has been described in connection with preferred embodiments, it will be understood that modifications thereof within the principles outlined above will be evident to those skilled in the art and thus, the invention is not limited to the preferred embodiments but is intended to encompass such modifications.

1. A method of making content associated with an event accessible to a communications device of an end user via a plurality of communication paths, the content comprising at least a streaming component, the method comprising:
(a) receiving the content into a server system in communication with the plurality of communication paths;
(b) providing information to the end user on how to access the content;
(c) receiving an indication from the end user to receive the content via a selected one of the plurality of communication paths, the indication corresponding to an action taken by the end user in requesting the content;
(d) determining a format for the streaming component of the content requested by the end user appropriate for transmission to the end user via the selected communication path;
(e) converting the streaming component into the determined format, if the content is a format different from the determined format; and
(f) transmitting at least the streaming component of the content to the communications device of the end user via the selected communication paths.

2. The method of claim 1, wherein step (b) comprises embedding a link in a web page pointing to the content and the action taken by the end user is clicking on the link.

3. The method of claim 2, wherein the selected one of the communication paths is the world wide web.

4. The method of claim 2, wherein the communications device of the end user is a computer.

5. The method of claim 2, wherein the communications device of the end user is a cellular phone.

6. The method of claim 2, wherein the communications device of the end user is a hand held computing device.

7. The method of claim 6, wherein the hand held computing device is a personal digital assistant.

8. The method of claim 1, wherein step (b) comprises providing a telephone access number and a code to the end user, the code being associated with the streaming component of the content, and wherein step (c) comprises calling the telephone access number and inputting the code.

9. The method of claim 8, wherein step (e) comprises:
decoding the streaming component into an audio file and converting the audio file into voice data capable of being received by a telephone.

10. The method of claim 9, wherein the telephone is a cellular phone.

11. The method of claim 9, wherein the telephone is a wireless device.

12. The method of claim 9, wherein the streaming component is decoded into a non-streaming format.

13. The method of claim 13, wherein the selected one of the communication paths is a publicly switched telephone network.

14. The method of claim 1, wherein the selected one of the communication paths is a cellular network.

15. The method of claim 1, wherein the selected one of the communication paths is a digital communications network.

16. The method of claim 1, wherein the content further comprises a non-streaming component.

17. The method of claim 16, wherein a script of commands embedded in the content is associated with the component and step (b) comprises providing the end user with a link to access the non-streaming component and step (f) comprises transmitting the non-streaming component of the content to the end user according to the script of commands.

18. The method of claim 17, wherein the nonstreaming component comprises a series of images and the script of commands defines a sequence according to which the images are transmitted, and step (f) further comprises:
pinging the communications device of the end user to determine which of the images of the series of images was last transmitted to the communications device; and
transmitting a next one of the images to the communications device according to the sequence.

19. The method of claim 19, wherein the images are presentation slides.

20. The method of claim 17, wherein the non-streaming component comprises a series of web pages and the script of commands defines a sequence in which the web pages are transmitted and step (f) further comprises:
pinging the communications device of the end user to determine which of the web pages was last transmitted to the communications device; and
transmitting a next one of the web pages to the communications device according to the sequence.

21. The method of claim 1, further comprising receiving the content from an external source communicatively connected to the server system.

22. The method of claim 21, wherein the content is received in a non-streaming format and the method further comprises converting the content into a streaming format.

23. The method of claim 22, wherein the step of converting the content into a streaming format comprises:
digitizing the content;
compressing the digitized content;
packetizing the digitized and compressed content; and
encoding the content into the streaming format

24. A system for providing access to content associated with an event to an end user via a plurality of communication paths, the system comprising:
a server system for receiving the content from an external source, the server system comprising:
a first server in communication with the external source, the first server for receiving the content and converting at least a portion of the content into a first format;
a second server for encoding the content;
a third server for storing the content, the third server capable of transmitting the content via a first one of the communication paths through a first interface;
a fourth server for decoding the content into an intermediate format; and
a fifth server for converting the content into a format transmissible via a second one of the communication paths through a second interface;
wherein, in response to a request from the end user to receive at least a portion of the content on the second interface, the server system converts the portion of the content into the format, such that the converted portion of the content is transmissible via the second interface.

25. The system of claim 24, wherein the first interface is connected to the world wide web and the second interface is connected to a telephone network and wherein said first format is a streaming media format and said second format a voice signal.

26. The system of claim 24, wherein said intermediate format is a digitized audio file.
